(19) United States
(12) Patent Application Publication
(10) Pub. No.: US 2013/0087994 A1
(43) Pub. Date: Apr. 11, 2013

(54) Foldable Golf Cart

(71) Applicant: Michael James Pratt, Draper, UT (US)

(72) Inventor: Michael James Pratt, Draper, UT (US)

(21) Appl. No.: 13/271,027

(22) Filed: Oct. 11, 2011

(51) Int. Cl. B62B 3/02

(52) U.S. Cl. 280/651

(57) ABSTRACT

A foldable golf pull/push cart is disclosed. In some embodiments, the foldable golf cart is selectively foldable between a folded configuration and an unfolded configuration. In such embodiments, the foldable golf cart is configured to be permanently attached to a golf club bag in both the folded and unfolded configurations as well as while the golf cart is transitioned between the forgoing configurations. According to some embodiments, the golf cart is compact and light enough such that it does not appreciably add to either the dimensions of the golf club bag or the weight of a standard golf club bag containing clubs and other golf equipment. In this way, when the golf cart is in a folded configuration, the golf cart and bag combination can be handled and/or transported as easily as the bag itself. In some embodiments, the golf cart is configured to accommodate any bag a user prefers.

### FIELD AND BACKGROUND OF THE INVENTION

1. Field of the Invention

The present invention relates to foldable golf push/pull carts for transporting a golf club bag, which holds a user's golf clubs and/or other golf gear, around a golf course. More specifically, the invention relates to a golf cart that, when collapsed, is light enough to be carried together with the golf club bag yet compact enough, while attached to the golf club bag, to fit in small storage spaces, such as the trunk of a car, thus permitting the golf club bag to be permanently attached to the golf cart.

2. Background and Related Art

A golf push/pull cart (hereinafter “golf cart” or “cart”) is a popular means for carrying or transporting a golf club bag around a golf course. While a golf cart is a convenient and cost effective amenity for use on the course, it is often an extra burden to carry on and off the course. Specifically, golf clubs, a golf club bag and/or a golf cart are typically transported in the trunk of a car to the golf course. Often, the cart is a separate piece of equipment from the bag. Accordingly, once a user arrives at the course, the cart must be expanded and the bag must be mounted and strapped to the cart to facilitate transporting the bag around the course. After use, the bag must be unstrapped and removed from the cart so that the cart can be collapsed and replaced in the trunk of the car. If the user leaves the bag attached to the cart, assuming the bag and the cart can remain attached when the cart is collapsed, the bag and cart combination is too large, cumbersome and heavy to be handled together and/or placed in the trunk of a car or otherwise transported via the bag's shoulder strap. A conventional golf cart, therefore, is typically inconvenient; the user must repeatedly attach the bag to the cart and detach the bag from the cart before and after every use. While several bag and cart combinations have been devised to partially alleviate the shortcomings and other inconveniences articulated above, all such combinations require a specific or “mating” cart and bag. Indeed, such bag and cart combinations are traditionally sold together as a single unit because only a specially designed and dedicated cart can be used in combination with a specific corresponding bag. As a result, users do not have the choice to use any brand of golf bag that they may prefer or already own.

### BRIEF SUMMARY OF THE INVENTION

A foldable golf push/pull cart adapted to be permanently attached to a golf club bag is disclosed. In some embodiments, wherein the bag has previously been attached to the golf cart, the golf cart is capable of being expanded for rolling use and/or collapsed and stowed without removing the bag. In such embodiments, the wheels of the golf cart are capable of folding and unfolding while the bag remains attached to the golf cart. Further, in some embodiments, the wheels are structured such that the wheels fold up next to the golf cart and the enclosed golf club bag during the folding process and ultimately come to lie alongside the bag, as opposed to hanging below the bag, when the golf cart is in a fully collapsed configuration. In other words, as the golf cart (along with the attached bag) is collapsed, according to some embodiments, the wheels of the golf cart approach to each other. Further, the wheel support legs and cart handle fold flat underneath the bag. Accordingly, when the golf cart is folded or assumes a collapsed configuration, the dimensions of the golf cart are not appreciably larger than the dimensions of the golf club bag alone. Specifically, the golf cart adds only marginally to the width of the golf club bag by the width of the wheels on either side of the bag. Further, the golf cart does not appreciably add to the length the bag. Finally, the golf cart is adapted to add only slightly to the depth of the golf club bag in embodiments having wheels designed to be larger than the depth of a golf club bag. On the other hand, in some embodiments, as the golf cart is unfolded, the wheels expand to form a broad and elongated stable wheel base when the golf cart is in a fully expanded configuration.

In some additional embodiments, the golf cart is constructed of light materials, and does not appreciably add to the overall weight of a golf club bag with a standard set of clubs and other golf gear normally carried with a golf club bag. According to such embodiments, when the golf cart is in a collapsed configuration, the golf club bag and golf cart combination can be handled together, carried from a shoulder strap of the bag, carried from a handle on the bag, or carried by the frame of the golf cart itself just as easily and conveniently as handling or carrying the bag itself. As a result, the cart can be left permanently attached to the bag thereby eliminating both the inconvenience of having to carry and/or stow the cart as a separate piece of equipment and the necessity of repeatedly attaching and detaching the bag from the cart before and after every use, as is the case for all existing conventional golf carts. In some embodiments, the golf pull cart is compact and light enough to be permanently attached to the bag and can easily be attached to most standard golf bags giving the user a choice of using any brand of golf bag they might prefer or already own. Thus, in order to use the cart, users are not limited to a dedicated, specially designed golf bag, as is the case for all existing conventional golf carts.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a non-limiting example of a prospective view of a golf cart from the side in an extended position;

FIG. 2 illustrates a non-limiting example of a side elevation view of the cart in a partially collapsed configuration;

FIG. 3 illustrates a non-limiting example of a golf cart in a completely collapsed position;

FIG. 4 illustrates a non-limiting example of another prospective view of a golf cart from the front in an extended position;

FIG. 5 illustrates a non-limiting example of yet another prospective view of a golf cart from the front in an extended position;

FIG. 6 illustrates a non-limiting example of a view of the handle assembly of the golf cart;

FIG. 7 illustrates a non-limiting example of a view of the offset wheel connection of the golf cart; and

FIGS. 8-12 illustrate an embodiment having an interlocking mechanism to provide additional structural reinforcement.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

The description may use perspective-based descriptions such as up/down, back/front, and top/bottom. Such descriptions are merely used to facilitate the discussion and are not intended to restrict the application or embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB)”, that is, A is an optional element.

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in various embodiments,” which may each refer to one or more of the same or different embodiments. Furthermore, the terms “comprising,” “including,” “having,” and the like, as used with respect to embodiments of the present invention, are synonymous with the definition afforded the term “comprising.”

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical or electrical contact. However, “coupled” may also mean that two or more elements are not in direct contact with each other, but yet still cooperate or interact with each other.

Referring now to the Figures, which depict various embodiments of a foldable golf push/pull cart 1 (hereinafter “golf cart”) according to the teachings of the present invention, a more detailed description of the component parts and/or features of the golf cart 1 will be provided. In the various embodiments, golf cart 1 is comprised of and assembled from numerous discrete parts which, for the sake of convenience, may be grouped together and discussed as subassemblies. It is to be understood, however, that during the use and/or operation of golf cart 1, the subassemblies are coupled, either directly or indirectly, to one another or otherwise interact in concert with one another. Moreover, while some embodiments comprise component parts which may be attributed to one subassembly or another for purposes of convenience and discussion, such is not intended to be limiting. Rather, component parts discussed with reference to one subassembly may be attributable to one or more additional subassemblies. Accordingly, by way of convenience and not limitation, golf cart 1 will be described in greater detail with reference to the following six (6) subassemblies: a handle assembly 8, a front wheel assembly 24; a rear wheel assembly 26; a golf club bag support system or cradle assembly 42; a transmission system 48; and a brake system 60. The manner in which the various subassemblies are connected to and interact with one another during the use and/or operation of golf cart 1 will discussed where appropriate and/or necessary.

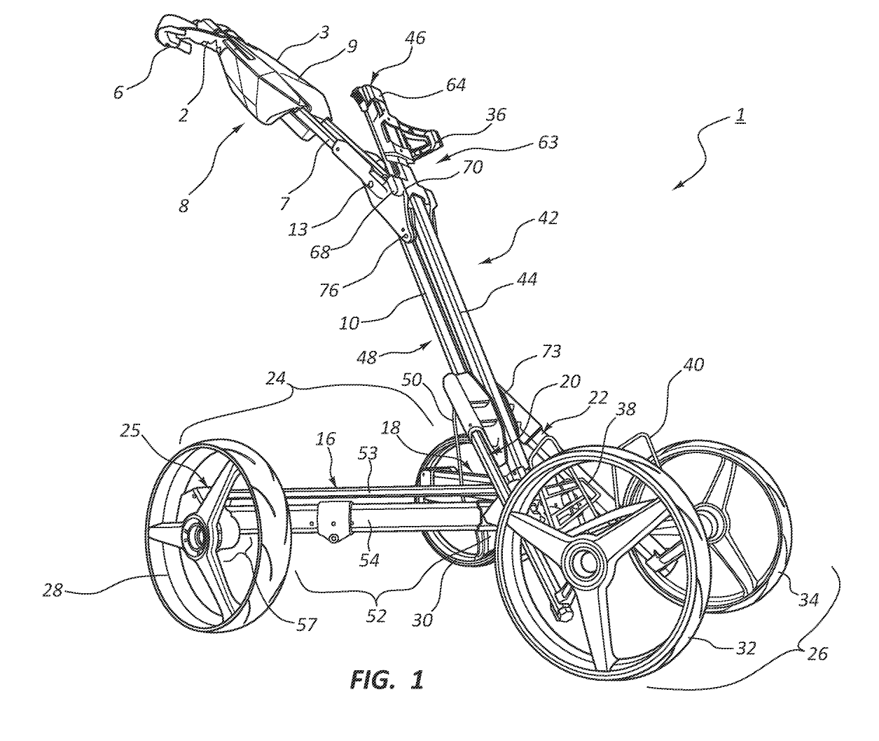

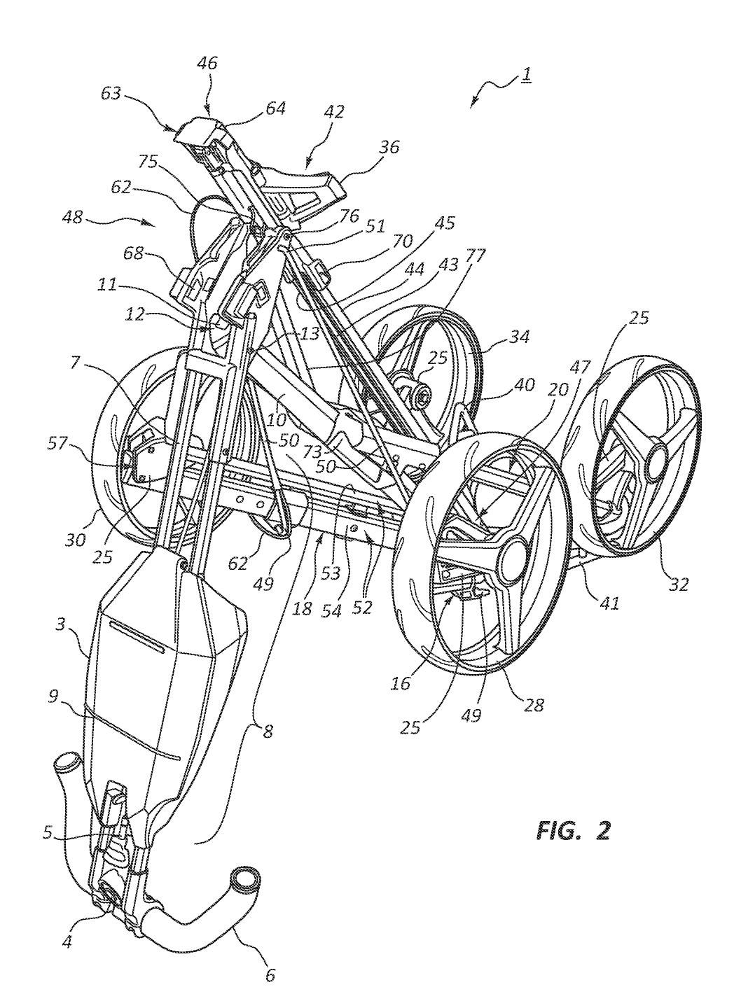

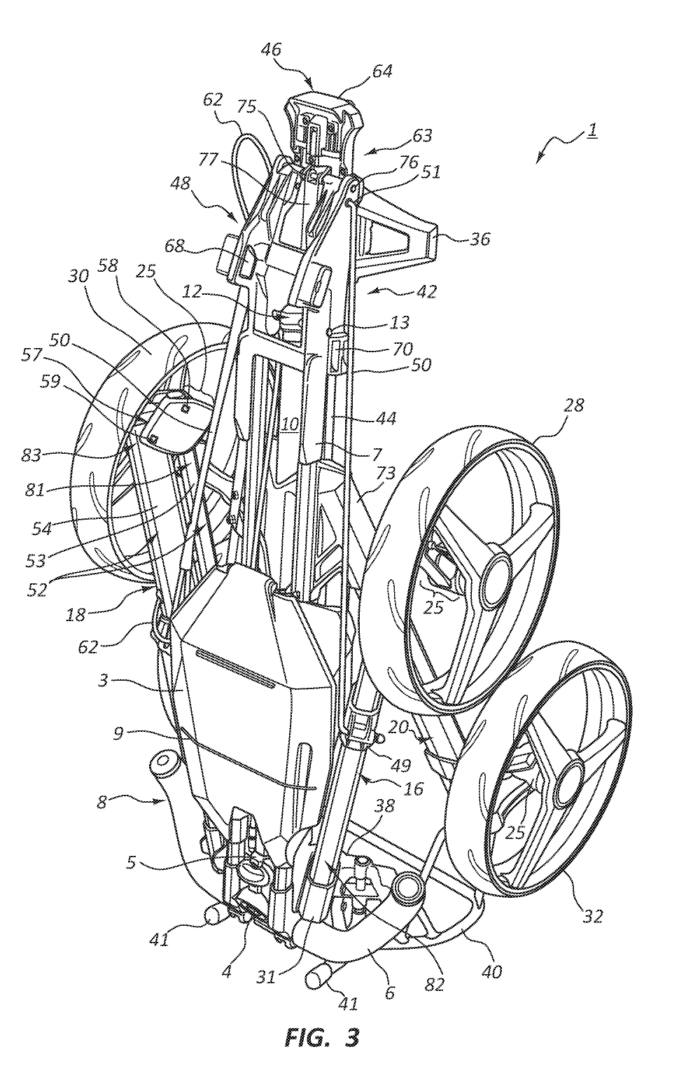

Prior to discussing the six (6) subassemblies identified above, it should be understood that in some embodiments golf cart 1 is configured to be manipulated between an upright, fully expanded or unfolded configuration, as shown in FIG. 1, through a partially closed position, as depicted in FIG. 2, to a completely collapsed, stowed or folded configuration, as seen in FIG. 3. In such embodiments, golf cart 1 is adapted to continuously accommodate and secure a golf club bag (not shown) throughout the transition from its fully expanded or upright configuration (FIG. 1) to its collapsed or stowed configuration (FIG. 3). It is further contemplated that golf cart 1 is adapted or configured to accommodate a golf club bag of virtually any make, model or having any dimensions, including standard dimensions as well as oversized or undersized golf club bags. Moreover, golf cart 1 is adapted to maximize the ease and convenience of transporting the golf club bag in either the golf cart's fully expanded or rolling configuration (FIG. 1) or in its collapsed or stowed configuration (FIG. 3) without adding appreciably to the overall dimensions of the golf club bag when the golf cart 1 is in its collapsed or stowed configuration. The foregoing is accomplished through the interaction of the golf cart's several subassemblies, as will be discussed in greater detail below. In addition, golf cart 1 is adapted to be light enough to be carried together with the golf club bag (via either the shoulder strap of the golf club bag, the handle of the golf club bag, or by the frame of golf cart 1 itself) while being compact enough, while collapsed and attached to the golf club bag, to fit in small storage spaces, such as the trunk of a car, thus permitting the golf club bag to be permanently attached to golf cart 1.

As illustrated in the several Figures, some embodiments comprise a handle assembly 8. In such embodiments, handle assembly 8 is generally comprised of a handle 6 located at the proximal end (as a user is pushing the cart) of handle assembly 8 and an extension member 7 located distally from handle 6. According to some embodiments, handle 6 is treated or otherwise covered with a relatively soft material so as to maximize comfort and control of golf cart 1 when a user grips handle 6.

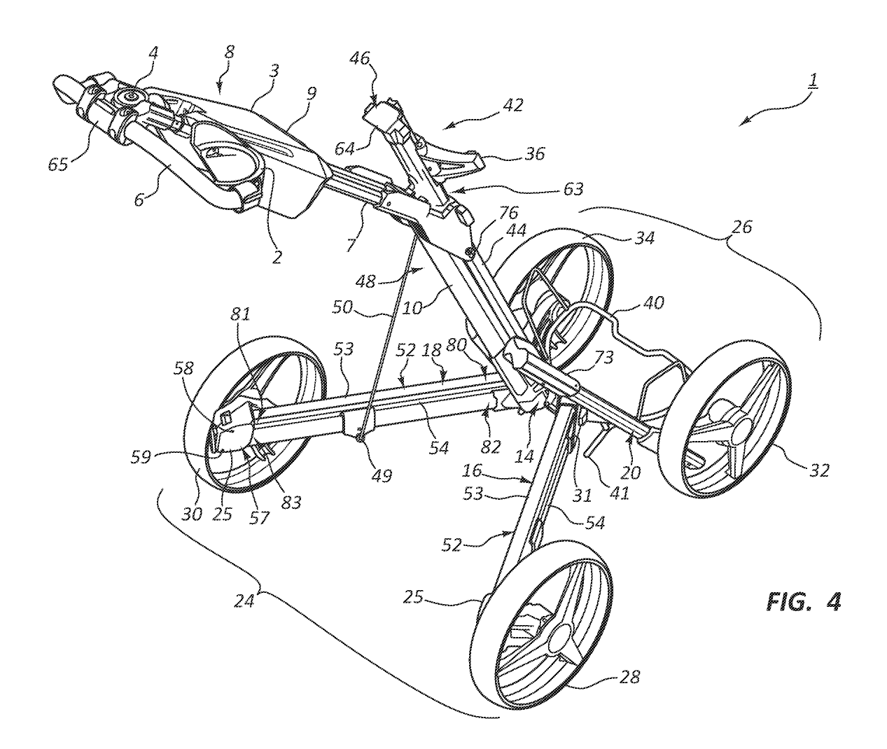

In various embodiments, handle assembly 8 may also include a variety of accoutrements for functional convenience and/or aesthetic appearance. By way of example and not limitation, in some embodiments handle assembly 8 includes one or more of the following: a cup holder 2 (FIG. 4), a storage compartment 3, an accessory port 4, a golf ball and/or golf tee cradle or magazine 5, an elastic restraining cord 9 or other similar functionally convenient and/or attractive features. In such embodiments, features such as the cup holder 2, the storage compartment 3, the accessory port 4, the golf ball and/or golf tee cradle or magazine 5, and/or the elastic restraining cord 9 are configured, shaped, and/or made from suitable materials to accomplish their intended function while accommodating other components of golf cart 1 so as to streamline the folded configuration of golf cart 1. For example, in some embodiments, as least a portion of the cup holder 2 may be comprised of webbing or strap-type material so as to adequately support a cup while being flexible enough not to impede the folding capacity of golf cart 1.

In other embodiments, handle assembly 8 is a convenient location for the proximate terminal end of other components or subassemblies of the golf cart 1. For example, in some embodiments the proximate terminal end of brake system 60 (discussed in greater detail below) is located at handle assembly 8 such that the brakes on golf cart 1 can be actuated or released from a location proximate handle 6. In various embodiments, handle assembly 8 is coupled at the terminal distal end of extension member 7 to a primary pivot coupler 75 (FIG. 2). Primary pivot coupler 75 facilitates several functional features of golf cart 1 and will be discussed in greater detail below.

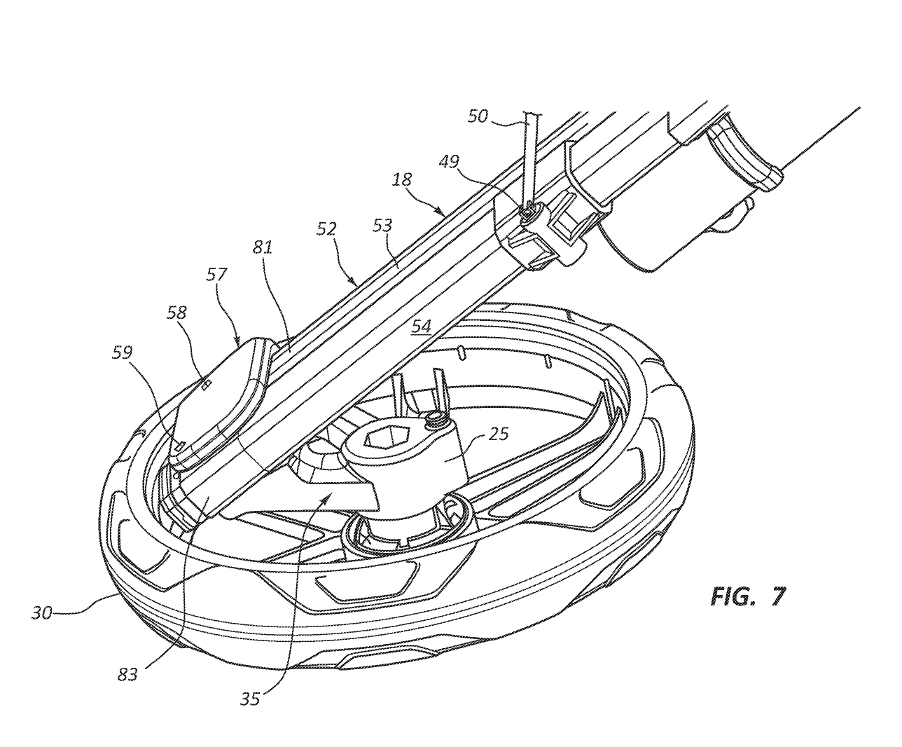

With continued reference to the Figures, some embodiments of golf cart 1 include a front wheel assembly 24. In various embodiments, front wheel assembly 24 is comprised of the following components: a first leg 16, a second leg 18, forward axel assemblies 25, a first front wheel 28, a second front wheel 30, struts 50, and a mounting bracket 31 (FIG. 3). In such embodiments, the first front wheel 28 is rotatably attachable to the unattached or otherwise free lower end of the first leg 16 via an independent forward axle assembly 25. Similarly, the second front wheel 30 is rotatably attachable to the unattached or otherwise free lower end of the second leg 18 via a second independent forward axle assembly 25. In some embodiments, as clearly shown in FIG. 7, the forward axle assemblies 25 are configured to facilitate an offset connection 35 between the first and second front wheels 28, 30 and the first and second legs 16, 18, respectively. In other words, in such embodiments, the front wheels 28, 30 comprise an offset connection 35 to golf cart 1.

In some embodiments, the first leg 16 and the second leg 18 are attached to golf cart 1 opposite one another such that the front wheel assembly 24 is symmetrical. Similarly, in some embodiments, the forward axel assembly 25 and strut 50 associated with the first leg 16 are minor image components relative to the forward axel assembly 25 and strut 50 associated with the second leg 18. In asymmetrical embodiments, however, the forward axle assembly 25 and strut 50 associated with the first leg 16 may differ from equivalent components associated with the second leg 18.

In some embodiments, the first leg 16 and the second leg 18 are preferably pivotally attached between the mounting bracket 31 (FIG. 3) and an axle assembly 25, respectively. In such embodiments, a pivotally attached front wheel assembly 24 allows the front wheels 28, 30 of golf cart 1 to fold from a fully extended or rolling configuration (FIG. 1) through a partially closed position (FIG. 2) to a completely collapsed or stowed configuration (FIG. 3). As illustrated in the various Figures, as golf cart 1 is collapsed according to some embodiments, the front wheel assembly 24 simultaneously retracts in two dimensions such that the front wheels 28, 30 move longitudinally towards the enclosed golf club bag (not shown) while at the same time laterally squeezing or narrowing in the direction of the sides of the enclosed golf club bag, respectively, thereby effectively decreasing both the width and depth of the golf cart 1 when it is in the collapsed position. In other words, as golf cart 1 is collapsed, the front wheels 28, 30 rotate upward toward the enclosed golf club bag while simultaneously narrowing relative to the sides of the enclosed golf club bag. In this manner, the front wheels 28, 30 lie alongside or adjacent to the golf club bag when golf cart 1 is in the collapsed position. The foregoing transition is accomplished without the necessity of ever removing the enclosed golf club bag comparing the cart in its expanded formation in FIG. 1 with its partially contracted formation in FIG. 2 and its fully contracted form in FIG. 3 helps to illustrate the process of contraction.

Conversely, and with continued reference to the Figures, as golf cart 1 is extended according to some embodiments, the front wheel assembly 24 simultaneously expands in two dimensions such that the front wheels 28, 30 move both longitudinally and laterally away from the enclosed golf club bag (not shown) thereby effectively increasing both the width and depth of the golf cart 1 when it is in the extended position. In other words, as golf cart 1 is expanded, the front wheels 28, 30 rotate downward away from the enclosed golf club bag while simultaneously displacing or broadening relative to the sides of the golf club bag. Again, the foregoing transition is accomplished without the necessity of ever removing the enclosed golf club bag.

In various embodiments, the first leg 16 and the second leg 18 are comprised of a bifurcated leg system 52, respectively. In such embodiments, bifurcated leg system 52 comprises an upper leg member 53 and a lower leg member 54 attached, either directly or through other physical structures, to the mounting bracket 31 (FIG. 3) and the axle assembly 25 via a series of pivotable and/or fixed points. According to some embodiments, upper leg member 53 has a first end 80 pivotally attached to mounting bracket 31 either directly or indirectly via connection through other ancillary members and/or various hardware means. In addition, upper leg member 53 also comprises a second end 81 which is pivotally coupled either directly or indirectly to an axle assembly 25. In systems utilizing a bifurcated leg system 52, the system further comprises a lower leg member 54 with a first end 82 pivotally attached to mounting bracket 31, either directly or via other physical structures, and a second end 83 pivotally coupled, either directly or indirectly, to an axle assembly 25. Accordingly, in a bifurcated leg system 52, as illustrated in the Figures, the upper and lower leg members 53, 54 maintain a parallel relationship to each other when golf cart 1 is in a fully expanded position, a collapsed position, or as the golf cart 1 is being transitioned between such positions.

As mentioned above, in preferred embodiments, the first and second front wheels 28, 30 are attachable to independent axle assemblies 25, respectively, such that they may freely rotate about the axel assemblies 25 as illustrated in the Figures. In embodiments that utilize a bifurcated leg system 52, the system is structured such that the first ends 80, 82 of the upper and lower leg members 53, 54, respectively, are coupled to the mounting bracket 31 while the second ends 81, 83 of the upper and lower leg members 53, 54, respectively, are coupled to an axle assembly 25 (i.e., a bifurcated wheel attachment system 57 (FIG. 7) comprising a top axle assembly pivot 58 and a bottom axle assembly pivot 59). In this way, upper leg member 53 and lower leg member 54 continuously maintain a physically parallel relationship to one another while simultaneously allowing the first and second front wheels 28, 30 to maintain a perpendicular relationship with the ground surface.

In some embodiments, the effect of providing a bifurcated leg system 52 allows the front wheel assembly 24, which is pivotally attached to golf cart 1, to provide a relatively wide and elongated front wheel base when golf cart 1 is in an upright or extended position (FIG. 1) and to provide a relatively narrow and shortened front wheel base when golf cart 1 is in a collapsed position (FIG. 3). Specifically, in such embodiments, the configuration of bifurcated leg system 52 simultaneously allows the first and second front wheels 28, 30 to be displaced both longitudinally as well as laterally when the golf cart 1 is in the extended or upright configuration such that the wheel base of golf cart 1 is effectively broadened and elongated. In this way, the golf cart's rolling stability and efficiency is enhanced. On the other hand, bifurcated leg system 52 permits the golf cart's effective wheel base to be narrowed and shortened when golf cart 1 is transitioned to the collapsed position so as to minimize the dimensions of golf cart 1 when it is to be stowed. In this way, golf cart 1 may be conveniently and easily deposited into and/or removed from a storage receptacle, such as the trunk of a car or other compact storage spaces. Accordingly, the combination of fixed and pivotable attachments in the bifurcated leg system 52 contributes to the golf cart's capacity to collapse for transportation and/or storage and to expand for rolling use.

In some further embodiments, the offset connection 35 between the first and second front wheels 28, 30 and the first and second legs 16, 18, respectively (FIG. 7), further contributes to the golf cart's capacity to provide a relatively wide and elongated front wheel base when golf cart 1 is in an upright or extended position (FIG. 1) and to provide a relatively narrow and shortened front wheel base when golf cart 1 is in a collapsed position (FIG. 3).

In embodiments comprising the bifurcated leg system 52, it is contemplated that, when golf cart 1 is in its fully collapsed configuration (FIG. 3), the geometry of the front wheel assembly 24 will remain sufficiently broad to accommodate a golf club bag (not shown) between the cavity defined by the first and second front wheels 28, 30. On the other hand, it is further contemplated that, when the golf cart 1 is in its fully collapsed configuration (FIG. 3), the geometry of the front wheel assembly 24 will be sufficiently narrow so that front wheel assembly 24 does not appreciably add to the overall dimensions of the golf club bag. Specifically, it is contemplated that golf cart 1 will only marginally add to the width of the golf club bag by the width of the front wheels 28, 30 which lie alongside the golf club bag when golf cart 1 is collapsed. Further, golf cart 1 does not appreciably add to the length the bag Likewise, golf cart 1 is adapted to add only slightly to the depth of the golf club bag in embodiments having front wheels 28, 30 designed to be larger than the depth of a golf club bag.

In various embodiments, struts 50 are adapted to facilitate the physical positioning and repositioning (i.e., retracting and/or displacing) of the front wheel assembly 24 as golf cart 1 is transitioned back and forth between a fully expanded or upright position (FIG. 1) and a completely collapsed configuration (FIG. 3). To this end, struts 50 will be discussed in greater detail below.

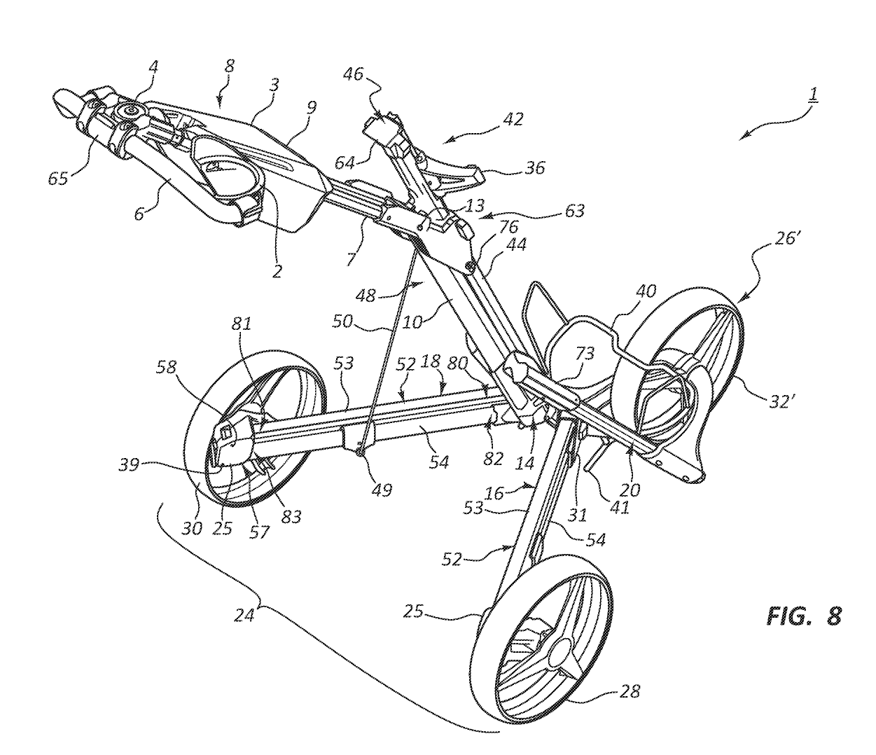

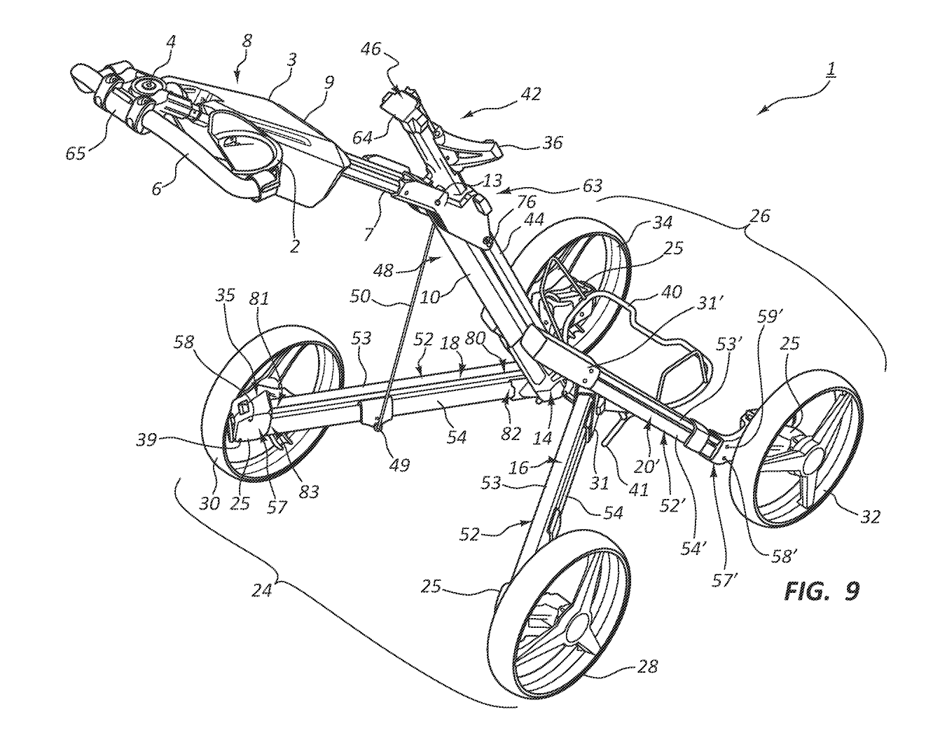

As mentioned above, some embodiments of golf cart 1 include a rear wheel assembly 26. While the bifurcated leg system 52 shown in FIGS. 1 through 5 and discussed above is only depicted and discussed in relation to the front wheel assembly 24, in alternative embodiments (FIG. 8) the bifurcated leg system 52 may also, or alternatively, be utilized in a rear wheel assembly 26. In such embodiments, the rear wheel assembly 26 comprising the bifurcated leg system 52 may be configured and adapted to function as described above with reference to the front wheel assembly 24. In this way, the bifurcated leg system 52 would effectively allow the rear wheel assembly 26, instead of or in addition to the front wheel assembly 24, to decrease in width and length as golf cart 1 is collapsed (thus decreasing the overall size of golf cart 1 while golf cart 1 is collapsed) but to increase in width and length as golf cart 1 is expanded (thus providing a broadened stable base when golf cart 1 is in an extended position).

In some embodiments, the first leg 16, second leg 18, third leg 20 and/or forth leg 22 are similar to one another in both their structure and operation. In other embodiments, the first leg 16, second leg 18, third leg 20 and/or forth leg 22 are dissimilar from one another in either their structure or operation. For example, in the various embodiments contemplated by the invention, none, some, one or all of the first leg 16, second leg 18, third leg 20 and/or forth leg 22 may comprise the bifurcated leg system 52. In some additional embodiments, each of the first leg 16, second leg 18, third leg 20 and/or forth leg 22 operate in concert with one another. In such embodiments, the front wheel assembly 24 operates in concert with the rear wheel assembly 26. In other embodiments, however, one or more of the first leg 16, second leg 18, third leg 20 and/or forth leg 22 operate separately and independently from one another. In such embodiments, for example, one leg may be extended while another is retracted and so forth. Further, in such embodiments, either the front wheel assembly 24, the rear wheel assembly 26 or both are comprised of one or more legs which operate independently of one another.

In other embodiments, however, and with continued reference to the Figures, the rear wheel assembly 26 is comprised of a third leg 20, a fourth leg 22, rear axle assemblies 25, a first rear wheel 32, a second rear wheel 34, and a primary slidable coupler 73. According to some embodiments, as described with reference to the front wheel assembly 24, the first rear wheel 32 is rotatably attachable to the unattached or otherwise free lower end of the third leg 20 via an independent rear axle assembly 25. Similarly, the second rear wheel 34 is rotatably attachable to the unattached or otherwise free lower end of the fourth leg 22 via another separate and independent rear axle assembly 25. In such embodiments, however, the opposite or upper ends of the third leg 20 and the fourth leg 22 are, respectively, connected to the primary slidable coupler 73. Akin to the forward axle assemblies 25, in some embodiments, the rear axle assemblies 25 are configured to facilitate an offset connection between the first and second rear wheels 32, 34 and the third and fourth legs 20, 22, respectively. In other words, in such embodiments, the rear wheels 32, 34 comprise an offset connection to golf cart 1.

As with first and second legs 16 and 18, in some embodiments, the third leg 20 and the fourth leg 22 are attached to the primary slidable coupler 73 opposite one another such that the rear wheel assembly 26 is symmetrical relative to the longitudinal axis of golf cart 1. In such embodiments, the rear wheel assembly 26 forms an “A” shape as depicted in the Figures. In other embodiments, however, asymmetrical leg configurations (not shown) are also contemplated. Similarly, in some embodiments, the rear axle assembly 25 associated with the third leg 20 is a mirror image component relative to the rear axle assembly 25 associated with the fourth leg 22. In asymmetrical embodiments, however, the rear axle assembly 25 associated with the third leg 20 may differ from the equivalent component associated with the fourth leg 22.

In some embodiments, the third leg 20 and the fourth leg 22 are preferably rigidly attached to the primary slidable coupler 73. Such embodiments enhance the structural integrity of the rear wheel assembly 26 and allow the third leg 20, the fourth leg 22 and the first and second rear wheels 32, 34 to maintain their orientation relative to one another as well as the slidable coupler 73 when golf cart 1 is in its upright or rolling configuration (FIG. 1), its collapsed or stowed configuration (FIG. 3), or as golf cart 1 is transitioned between such configurations (FIG. 2). Such embodiments also permit the rigid rear wheel assembly 26 of golf cart 1 to slide (via primary slidable coupler 73) from a fully extended or rolling configuration (FIG. 1) to a completely collapsed or stowed configuration (FIG. 3). As illustrated in the various Figures, as golf cart 1 is collapsed according to some embodiments, rear wheel assembly 26 simultaneously retracts in one dimension such that rigid rear wheel assembly 26 moves longitudinally towards the enclosed golf club bag (not shown) thereby effectively decreasing the depth of golf cart 1 when it is in the collapsed position. In this manner, the rear wheels 32, 34 lie alongside or adjacent the golf club bag (not shown) when golf cart 1 is in the collapsed position. Conversely, and with continued reference to the Figures, as the golf cart 1 is extended according to some embodiments, rear wheel assembly 26 simultaneously expands in one dimension such that the first and second rear wheels 32, 34 move longitudinally away from the enclosed golf club bag (not shown) thereby effectively increasing the depth of golf cart 1 when it is in the extended position. As with the front wheel assembly 24, the foregoing transition is accomplished without the necessity of ever removing the enclosed golf club bag.

In some embodiments, providing a rigid rear wheel assembly 26, which is slidably attached to golf cart 1, allows the wheel base of golf cart 1 to be elongated when golf cart 1 is in an upright or extended position (FIG. 1) and to be shortened when golf cart 1 is in a collapsed position (FIG. 3). Specifically, in such embodiments, the configuration of slidable rear wheel assembly 26 allows the first and second rear wheels 32, 34 to be displaced longitudinally when golf cart 1 is in the extended or upright configuration such that the wheel base of golf cart 1 is effectively elongated. In this way, the golf cart's rolling stability and efficiency is enhanced. On the other hand, the slidable rear wheel assembly 26 permits the golf cart's effective wheel base to be shortened when golf cart 1 is transitioned to the collapsed position so as to minimize the length of golf cart when it is to be stowed. In this way, the golf cart 1 may be conveniently and easily deposited into and/or removed from a storage receptacle, such as the trunk of a car or other compact storage spaces. Accordingly, the slidable rear wheel assembly 26 contributes to the golf cart's capacity to collapse for transportation and/or storage and to expand for rolling use.

In some further embodiments, the offset connection between the first and second rear wheels 32, 34 and the third and fourth legs 20, 22, respectively, further contributes to the golf cart's capacity to collapse for transportation and/or storage and to expand for rolling use.

In embodiments comprising a slidable rigid rear wheel assembly 26, it is contemplated that the geometry of the rear wheel assembly 26 is sufficiently broad to accommodate a golf club bag (not shown) and other components of golf cart 1 (i.e., the cradle assembly 42, discussed in greater detail below) between the cavity defined by the first and second rear wheels 32, 34 such that the golf club bag does not interfere with either the operation of the first and second rear wheels 32, 34 or the transition of the rear wheel assembly 26 between its expanded and collapsed configurations. On the other hand, it is further contemplated that the geometry of the rear wheel assembly 26 is sufficiently narrow so that rear wheel assembly 26 does not appreciably add to the overall dimensions of the golf club bag when golf cart 1 is in its collapsed or stowed configuration. Specifically, it is contemplated that golf cart 1 will only marginally add to the width of the golf club bag by the width of the rear wheels 32, 34 which lie alongside the golf club bag when golf cart 1 is collapsed. Further, golf cart 1 does not appreciably add to the length the bag. Likewise, golf cart 1 is adapted to add only slightly to the depth of the golf club bag in embodiments having rear wheels 32, 34 designed to be larger than the depth of a golf club bag.

In some embodiments, the combination of the front wheel assembly 24 (which comprises the bifurcated leg system 52 in some embodiments) and the rigid rear wheel assembly 26 contributes to the golf cart's capacity to provide a stable and efficient rolling chassis when golf cart 1 is expanded (FIG. 1) while being compact or otherwise having a relatively low profile when golf cart 1 is collapsed (FIG. 3).

As mentioned above, the primary slidable coupler 73 is adapted to facilitate the physical positioning and repositioning (i.e., retracting and/or displacing) of rear wheel assembly 26 as golf cart 1 is transitioned back and forth between a fully expanded or upright position (FIG. 1) and a completely collapsed configuration (FIG. 3). To this end, primary slidable coupler 73, as well as its relationship to other components comprising golf cart 1, will be discussed in greater detail below.

With continued reference to the Figures, and particularly FIG. 1, some embodiments of golf cart 1 include the golf bag support system or cradle assembly 42. In various embodiments, the cradle assembly 42 is comprised of the following components: a longitudinal support beam 44 defining the undercarriage 45 of the cradle assembly 42, an upper cradle 36, a lower cradle 38, and a foot 40. In such embodiments, longitudinal support beam 44 extends in a longitudinal direction and comprises an upper end 46 and a lower end 47. In some embodiments, longitudinal support beam 44 is straight as depicted in the accompanying Figures. Such embodiments of longitudinal support beam 44 further include a channel 43 (FIG. 2) formed within or otherwise defined by the longitudinal support beam 44. In alternative embodiments, however, longitudinal support beam 44 may be curved at one or more points along its length. In such embodiments, channel 43 may be formed from or otherwise defined by other components (not shown).

In embodiments comprising cradle assembly 42, the upper cradle 36 is attached to the upper end 46 of longitudinal support beam 44. In such embodiments, upper cradle 36 provides a surface extending laterally from longitudinal support beam 44. In further embodiments, as depicted in the Figures, upper cradle 36 may provide surfaces, flanges or tabs which extend both laterally and upward relative to longitudinal support beam 44. The upper cradle 36 is adapted to receive and secure the upper end or portion of a golf club bag (not shown) when the golf club bag is mounted to golf cart 1. Similarly, some embodiments comprise a lower cradle 38 attached to the lower end 47 of longitudinal support beam 44. In such embodiments, the lower cradle 38 similarly provides a surface extending either laterally, upward, or both from longitudinal support beam 44 in order to receive and secure the lower end of a golf club bag (not shown) when the golf club bag is mounted to golf cart 1. In other embodiments, lower cradle 38 may also comprise surfaces, tabs or flanges extending outward, upward and/or downward generally relative to longitudinal support beam 44. According to some embodiments, both the upper and lower cradles 36, 38 may also include or incorporate a series of adjustable straps and/or buckles (not shown) or similar attachment means common to those of skill in the art adapted to further secure the upper and lower ends of a golf club bag, respectively, to golf cart 1.

Some embodiments comprising the cradle assembly 42 also include a foot 40. According to some embodiments, foot 40 comprises a surface extending generally perpendicularly from longitudinal support beam 44 on which the bottom of the golf club bag (not shown) rests or is supported. In other words, foot 40 is adapted to further secure the bottom or lower end of the golf club bag. To this end, in some embodiments, foot 40 further includes flanges, tabs, or other surfaces adapted to support the mass of the golf club bag and/or adjustable straps, buckles or similar attachment means adapted to secure or otherwise retain the golf club bag against movement relative to golf cart 1 during storage, rolling use, or transportation. In some embodiments, foot 40 is attached, either directly or indirectly via other hardware or attachment means, to the lower end 47 of longitudinal support beam 44. For example, foot 40 may be attached to the lower cradle 38, the mounting bracket 31 (FIG. 3), and/or other various hardware means which in turn may be attached either directly or indirectly to the lower end 47 of longitudinal support beam 44.

In some embodiments, foot 40 may also include or comprise means 41 for stabilizing golf cart 1 when golf cart 1 is in a collapsed configuration such that golf cart 1 may stand up vertically on a substantially level ground surface without falling over and without leaning on or against external surfaces or objects outside of the ground surface. The stabilizing means 41 may include tabs, extensions, feet or other elongated elements integrally formed or attached to foot 40. According to some further embodiments, foot 40, including the stabilizing means 41, is treated or otherwise covered with a relatively soft material so as to minimize the likelihood that foot 40 will mar external surfaces in which foot 40 comes into contact.

With continued reference to the Figures, preferred embodiments of golf cart 1 comprise a transmission system 48. In some embodiments, transmission system 48 defines a longitudinal body or axis of golf cart 1. Various embodiments of the transmission system 48 comprise the following components: a central support member 10, a primary pivot coupler 75 (FIG. 2), a stay 77 (FIG. 2) and an actuation system 63. In some embodiments, the transmission system 48 is coupled to or otherwise structured to interact with handle assembly 8, front wheel assembly 24, rear wheel assembly 26 (for convenience, front wheel assembly 24 and rear wheel assembly 26 will subsequently be referred to collectively as the “leg system 15” unless otherwise specified) and/or cradle assembly 42 of golf cart 1 via longitudinal support beam 44, struts 50, and/or primary slidable coupler 73 to allow golf cart 1 to be transitioned back and forth between an upright or fully expanded configuration for rolling use (FIG. 1) and a completely collapsed or stowed configuration for storage and/or transportation (FIG. 3). Each of the component elements common to some embodiments of transmission system 48 will be discussed in turn followed by a discussion of how, according to some embodiments, transmission system 48 interacts with the remaining subassemblies of golf cart 1 as previously identified.

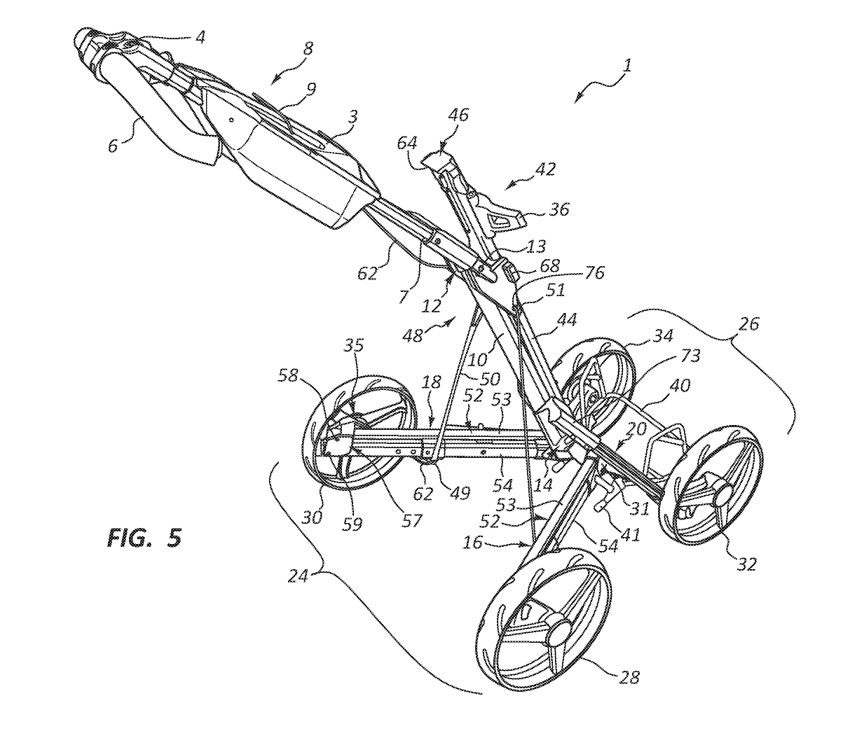

As mentioned above, some embodiments of transmission system 48 comprise a central support member 10. In such embodiments, central support member 10 extends in a generally longitudinal direction and comprises an upper end 12 and a lower end 14 (FIG. 5). In some embodiments, central support member 10 is straight as depicted in the accompanying figures. Such embodiments of central support member 10 further include a channel 11 formed within or otherwise defined by the central support member 10. In alternative embodiments, however, central support member 10 may be curved at one or more points along its length. In such embodiments, channel 11 may be formed from or otherwise defined by other components (not shown).

Various embodiments of transmission system 48 also comprise a primary pivot coupler 75. In some embodiments, primary pivot coupler 75 defines a pivot point in order to facilitate the pivotal engagement of one or more component parts of golf cart 1. In further embodiments, primary pivot coupler 75 is slidably retained within, or otherwise slidably engages, the channel 43 of longitudinal support beam 44 such that the primary pivot coupler 75 is longitudinally slidable along a length of longitudinal support beam 44. In embodiments contemplating a slidable engagement between primary pivot coupler 75 and channel 43 of the longitudinal support beam 44, the pivot point defined by primary pivot coupler 75 is also slidable in relation to the longitudinal support beam 44 and/or other components of golf cart 1.

In some further embodiments, primary pivot coupler 75 acts as a structural coupler between extension member 7 of handle assembly 8 and the leg system 15 of golf cart 1. For example, as discussed in greater detail below, in some embodiments, primary pivot coupler 75 structurally connects extension member 7 of handle assembly 8 to the front wheel assembly 24 by a pivotal connection to one or more struts 50. In other embodiments, primary pivot coupler 75 maintains a structural connection to the rear wheel assembly 26 via linkage through stay 77. In some embodiments, primary pivot coupler 75 effectively acts to translate the forces applied to handle 6 by a user through extension member 7 of handle assembly 8 to each of the wheels 28, 30, 32, 34 via the leg system 15. Accordingly, it is contemplated that primary pivot coupler 75 may be utilized to extend or retract the leg system 15 of golf cart 1. In preferred embodiments, and as depicted in the Figures, it is contemplated that forces applied to the handle 6 are effectively translated to displace or extend the wheel assemblies when the golf cart one is expanded (FIG. 1) and to retract the wheel assemblies when the golf cart is collapsed (FIG. 3).

As referenced above, some embodiments of transmission system 48 comprise a stay 77. Stay 77 further comprises a first end 78 (FIG. 3) and a second end 79. In some embodiments, the first and second ends of stay 77 are adapted to be pivotally coupled to adjacent components of golf cart 1. In further embodiments, stay 77 extends in a generally longitudinal direction.

Some embodiments of transmission system 48 further comprise an actuation system 63. Some embodiments of the actuation system 63 further comprise an actuation lever 64, a male coupler 68 and a female couple 70. In some embodiments, actuation lever 64 is spring loaded. In other embodiments, male coupler 68 is alternatively, or additionally, spring loaded. In various embodiments, the interaction of the male coupler 68 and the female coupler 70 permits actuation system 63 to be locked in an engaged position while allowing a user to selectively disengage the actuation system 63. Such embodiments further permit golf cart 1 to be locked or otherwise engaged in an upright or fully expanded configuration for rolling use (FIG. 1) and selectively disengaged or otherwise unlocked and collapsed to assume a fully stowed configuration for storage and/or transportation (FIG. 3).

With continued reference to the Figures, the manner in which transmission system 48 interacts with the remaining subassemblies of golf cart 1 according to some embodiments will now be discussed in greater detail. In embodiments comprising a central support member 10, the lower end 14 of central support member 10 is pivotally coupled to the lower end 47 of longitudinal support beam 44. In some embodiments, central support member 10 is directly pivotally coupled to longitudinal support beam 44 while in other embodiments the pivotal connection is accomplished via other intervening components and/or hardware assemblies. According to further embodiments, the upper end 12 of central support member 10 is pivotally coupled to a first pivot point 13 located at handle extension member 7. In yet further embodiments, the terminal distal end of the handle extension member 7 is in turn pivotally coupled to the primary pivot coupler 75 (which in some embodiments slidably engages or is slidably retained within the channel 43 (FIG. 2) of longitudinal support beam 44) at a second pivot point 76 defined by primary pivot coupler 75. In this manner, central support member 10 and longitudinal support beam 44 form a “V” shape that expands and contracts as golf cart 1 is transitioned back and forth between a fully expanded or upright position (FIG. 1) and a completely collapsed configuration (FIG. 3). In addition, as golf cart 1 is transitioned between its various configurations, primary pivot coupler 75 is permitted to slide along the length of longitudinal support beam 44 via channel 43 to accommodate the respective positions of the adjacent component parts to which primary pivot coupler 75 is coupled.

Specifically, with reference to FIG. 1, when golf cart 1 is engaged in a fully upright position, central support member 10 and longitudinal support beam 44 are vertically nearly adjacent to one another (i.e., central support member 10 is almost directly underneath the longitudinal support beam 44) such that the “V” shape is relatively shallow. As golf cart 1 is transitioned through a partially collapsed position, as shown in FIG. 2, the upper end 12 of central support member 10 and the upper end 46 of longitudinal support beam 44 separate such that the “V” shape expands to its zenith defined by the geometry of the various component parts. Finally, as golf cart 1 is fully collapsed, as shown in FIG. 3, central support member 10 and longitudinal support beam 44 return to a nearly adjacent position relative to one another (vertically) such that the “V” shape is again relatively shallow. When golf cart 1 is in the position depicted in FIG. 3, the primary pivot coupler 75 is proximate the upper end 46 of longitudinal support beam 44 but as the golf cart is transitioned to the configuration shown in FIG. 1, the primary pivot coupler 75 slides distally along the length of longitudinal support beam 44 until golf cart 1 achieves a fully expanded configuration.

As previously discussed, some embodiments of transmission system 48 comprise a stay 77. In some embodiments, the first end 78 (FIG. 3) of the stay 77 is pivotally coupled to primary pivot coupler 75, which in some embodiments slidably engages channel 43 (FIG. 2) of longitudinal support beam 44. And in preferred embodiments, the first end 78 of the stay 77 is coupled directly to the second pivot point 76. In this manner, according to some embodiments, the terminal distal end of extension member 7, the first end 78 of stay 77 and primary pivot coupler 75 are all coupled together and therefore move together as golf cart 1 is transitioned back and forth between an upright or fully expanded configuration for rolling use (FIG. 1) and a completely collapsed or stowed configuration for storage and/or transportation (FIG. 3). Moreover, in embodiments contemplating a slidable engagement between primary pivot coupler 75 and channel 43 of longitudinal support beam 44, the foregoing assembly (comprised of the terminal distal end of extension member 7, the first end 78 of stay 77 and primary pivot coupler 75) remains continuously engaged proximate longitudinal support beam 44 throughout the transition of golf cart 1.

Similarly, in some further embodiments, the second end 79 of stay 77 is coupled to primary slidable coupler 73, which in some embodiments slidably engages central support member 10. In other embodiments, primary slidable coupler 73 may alternatively, or additionally, engage channel 11 (FIG. 2) of central support member 10 similar to the manner in which primary pivot coupler 75 slidably engages channel 43 of longitudinal support beam 44 as discussed previously. As indicated, in some embodiments primary slidable coupler 73 is driven by structural relation with stay 77. According to such embodiments, the second end 79 of stay 77 and the primary slidable coupler 73 are both coupled together and therefore move together as golf cart 1 is transitioned back and forth between its upright and collapsed configurations. Moreover, in embodiments contemplating a slidable engagement between the primary slidable coupler 73 and central support member 10, the foregoing assembly (comprised of the second end 79 of stay 77 and primary slidable coupler 73) remains continuously engaged proximate central support member 10 throughout the transition of golf cart 1.

Some embodiments of transmission system 48 allow upward and downward forces applied to the handle assembly 8 to be transmitted to the leg system 15 such that golf cart 1 is transitioned back and forth between its upright and collapsed configurations by the application of such upward and downward forces, respectively. In other words, some embodiments of transmission system 48 translate forces applied directly to the handle assembly 8 into forces which act on the leg system 15 to either expand or collapse both the front wheel assembly 24 and the rear wheel assembly 26.

For example, as mentioned above, some embodiments of transmission system 48 are structured to interact with one or more struts 50. In such embodiments, each strut 50 comprises a first end 49 (FIG. 3), which according to some embodiments is structured to pivotally couple to one of the first leg 16, the second leg 18, the third leg 20 or the fourth leg 22 comprising the leg system 15. Each strut 50, in some embodiments, further comprises a second end 51, which according to some embodiments is structured to pivotally couple to handle extension member 7, handle assembly 8, central support member 10, longitudinal support beam 44 and/or cradle assembly 42. In a preferred embodiment, the second end 51 of strut 50 is pivotally coupled to extension member 7 which in turn is coupled to slidable primary pivot coupler 75 at second pivot point 76. In this manner, as a user applies force to or otherwise levers extension member 7 via handle assembly 8, the strut 50 transmits such force to one of the legs 16, 18, 20 or 22 comprising the leg system 15 effectively displacing the leg system 15 as golf cart 1 is expanded (FIG. 1) or retracting the leg system 15 as golf cart 1 is collapsed (FIG. 3). Specifically, as the handle assembly 8 is raised, strut 50 applies a downward force to the leg system 15 elongating and/or broadening the wheel base of golf cart 1. On the other hand, as the handle assembly 8 is lowered, strut 50 applies and upward force to the leg system 15 shortening and/or narrowing the wheel base of golf cart 1.

Embodiments which comprise the bifurcated leg system 52 and/or the bifurcated wheel attachment system 57, as previously discussed, further contribute to the translation of upward or downward forces applied to the handle assembly 8 into forces which narrow or broaden the overall width of the wheel base as well as elongate or shorten the overall length of golf cart 1. As depicted in the Figures, in some embodiments, struts 50 may be coupled to the first and second legs 16, 18 of the front wheel assembly 24. In other embodiments, it is contemplated that the struts 50 may alternatively, or additionally, be coupled to the third and fourth legs 20, 22 of the rear wheel assembly 26.

In other embodiments, wherein the first end 78 (FIG. 3) of stay 77 is pivotally coupled to primary pivot coupler 75 and the second end 79 of stay 77 is coupled to primary slidable coupler 73, as force is applied to the extension member 7 via handle assembly 8, stay 77 transmits a longitudinal force to the leg system 15 of golf cart 1. As force is applied to handle assembly 8, stay 77 transmits a longitudinal force to the leg system 15 such that the leg system 15 is effectively displaced as golf cart 1 is expanded (FIG. 1) or retracted as golf cart 1 is collapsed (FIG. 3). Specifically, as an upward force is applied to handle assembly 8 such that it is raised, stay 77 applies a longitudinal downward force to the leg system 15 via primary slidable coupler 73 effectively displacing the leg system 15 and thereby lengthening or elongating the overall length of golf cart 1. On the other hand, as handle assembly 8 is unlocked and pivoted downward, stay 77 applies a longitudinal upward force to the leg system 15 effectively retracting the leg system 15 and thereby shortening or decreasing the overall length of golf cart 1.

As depicted in the Figures, in some embodiments, slidable coupler 73 may be coupled to the third and fourth legs 20, 22 of the rear wheel assembly 26. In other embodiments, it is contemplated that the slidable coupler 73 may alternatively, or additionally, be coupled to the first and second legs 16, 18 of the front wheel assembly 24.

It is further contemplated that, in some embodiments, transmission system 48 is structured to interact simultaneously with one or more struts 50 to transmit forces to the front wheel assembly 24 as well as the stay 77 to transmit longitudinal forces to the rear wheel assembly 26. Consequently, in preferred embodiments, golf cart 1 is expandable and collapsible via raising or lowering, respectively, the handle assembly 8. Specifically, as handle assembly 8 is raised, transmission system 48 effectively transmits the corresponding forces via various linkages to simultaneously displace both the front wheel assembly 24 as well as the rear wheel assembly 26 thereby broadening the wheel base and elongating the overall length of the golf cart 1 at once. On the other hand, as handle assembly 8 is lowered, transmission system 48 effectively transmits the corresponding forces to simultaneously retract both the front wheel assembly 24 as well as the rear wheel assembly 26 thereby narrowing the wheel base and shortening the overall length of golf cart 1 at once. Moreover, it is contemplated that each of the foregoing transitions can be fully accomplished without the necessity of ever removing an enclosed golf club bag.

As mentioned above, some embodiments of transmission system 48 comprise an actuation system 63 such that golf cart 1 may be locked or otherwise engaged in an upright or fully expanded configuration for rolling use (FIG. 1) and selectively disengaged or otherwise unlocked and collapsed to assume a fully stowed configuration for storage and/or transportation (FIG. 3). In some embodiments, this is accomplished via user interaction of actuation lever 64 and handle assembly 8. In some embodiments, actuation lever 64 is slidably engaged with and/or about the upper end 46 of longitudinal support beam 44. In further embodiments, actuation lever 64 is spring loaded such that it is biased in a locked position wherein actuation lever abuts the upper end 46 of longitudinal support beam 44 when in a resting position. In such embodiments, actuation lever 64 is selectively unlockable.

Some embodiments of the actuation lever 64 are integrally formed with one or more female couplers 70. In other embodiments, the female couplers 70 may be attached to actuation lever 64. In still other embodiments, actuation lever 64 may be integrally formed with one or more male couplers 68 while in other embodiments actuation lever 64 may have such male couplers 68 attached thereto. In embodiments contemplating a spring loaded or biased slidable engagement between actuation lever 64 and longitudinal support beam 44, the male and/or female couplers 68, 70 formed with or otherwise connected to actuation lever 64 are also selectively slidable relative to longitudinal support beam 44 while being biased in a locked position.

In alternative embodiments, one or more female couplers 70 and/or one or more male couplers 68 may be integrally formed with or attached to handle assembly 8. In some embodiments, the male and/or female couplers 68, 70 are integrally formed with extension member 7. In other embodiments, the male and/or female couplers 68, 70 are attached to extension member 7. In the foregoing embodiments, the couplers associated with the actuation lever 64, whether male or female according to various embodiments, matingly correspond to the couplers associated with the handle assembly 8.

In some embodiments, male couplers 68 are spring loaded and biased in a locked position. In some further embodiments, male couplers 68 are chamfered on one or more sides such that when a force is applied to any one of the chamfered surfaces the biasing force of the spring may be overcome such that male couplers 68 are displaced or depressed into corresponding recesses or slots formed in adjacent components. Similarly, in some embodiments, female couplers 70 comprise a cavity having one or more angled surfaces which in some embodiments correspond with the chamfered surfaces on male couplers 68. In this manner, the male and female couplers 68, 70 may be selectively engaged and locked or selectively disengaged and unlocked.

In some embodiments, expanding and locking golf cart 1 in an upright rolling configuration is a streamlined operation that occurs as handle assembly 8 is rotated in a single motion. Specifically, as mentioned above, as handle assembly 8 is raised or rotated in an upward direction, transmission system 48 effectively transmits the corresponding forces via a series of linkages to simultaneously displace both the front wheel assembly 24 as well as the rear wheel assembly 26 thereby broadening the wheel base and elongating the overall length of golf cart 1. As handle assembly 8 is raised or rotated to its fully upward position, the couplers (male or female) integrally formed with or attached to the handle assembly 8 matingly engage the corresponding couplers integrally formed with or attached to the actuation lever 64 thereby locking the golf cart 1, and all the subassemblies thereof, in a fully expanded configuration (FIG. 1). In particular, as handle assembly 8 is raised or rotated upward, the one or more chamfered surfaces of male couplers 68 are forced against an external edge of female couplers 70. As a result, male couplers 68 are temporarily depressed into corresponding recesses as handle assembly 8 continues to be forced upward. Once handle assembly 8 is raised or rotated to a fully upward position, male couplers 68 move beyond the external edge of the corresponding female couplers 70 and the biasing spring drives the male couplers 68 into mating engagement with the female couplers 70 thereby locking the golf cart 1 in an expanded configuration.

On the other hand, unlocking and collapsing golf cart 1 such that it assumes a fully collapsed configuration is also a streamlined operation that occurs as the handle assembly 8 is rotated in a single motion. Specifically, as a user applies an upward force to the proximal end of actuation lever 64, the biasing force associated therewith is overcome. At the same time, the angled surfaces formed within female couplers 70 are forced against the one or more chamfered surfaces of male couplers 68 so as to drive the male couplers 68 into corresponding recess as actuation lever 64 is raised. Once actuation lever 64 is raised to a fully unlocked position, the handle assembly 8 is disengaged and may be lowered or rotated downward. As discussed above, when handle assembly 8 is lowered or rotated downward, transmission system 48 effectively transmits the corresponding forces via a series of linkages to simultaneously retract both the front wheel assembly 24 as well as the rear wheel assembly 26 thereby narrowing the wheel base and shortening the overall length of golf cart 1. As handle assembly 8 is lowered or rotated to its fully downward position, the leg system 15 and handle assembly 8 fold flat underneath the longitudinal body of golf cart 1 defined by transmission system 48. As further discussed above, each of the foregoing transitions can be fully accomplished without the necessity of ever removing an enclosed golf club bag (not shown).

In various embodiments, the golf cart 1 also includes a selectively lockable assembly comprised of elements common to those of skill the art such as female couplers, male couplers, cavities, spring loaded elements, chamfered elements, latches, hooks, straps, clasps, buttons, pivotal spring loaded elements, fasteners, keyways, tabs, levers, slots, and other corresponding and/or selectively engagable elements configured to selectively lock the golf cart 1 in its fully collapsed position. In such embodiments, the golf cart 1 is restrained against expanding while it is being lifted, handled or transported in its stowed configuration. In various embodiments, the corresponding lockingly engagable elements of the selectively lockable assembly are located at any suitable locations, respectively, such that they are proximate one another when the golf cart 1 is fully collapsed. For example, in some embodiments, a female coupler (or equivalent element) is located on the lower end 14 of the central support member 10. In such embodiments, a corresponding chamfered and spring loaded male coupler is located on the handle assembly 8 such that as the golf cart 1 is collapsed, the male coupler approaches the female coupler. As the handle assembly 8 is lowered to its fully collapsed position, the chamfered edge of the male coupler contacts a forward edge of the female coupler such that it is depressed into a corresponding cavity until the male coupler moves beyond the forward edge of the female coupler and lockingly engages the female coupler. In this way, the golf cart 1 is restrained in its collapsed position until the user selectively disengages the male and female couplers. Disengaging the couplers can be accomplished through a corresponding lever coupled to the male coupler. In another example, a strap fixed to the central support member 10 may be clasped around a portion of the handle assembly 8 when the golf cart 1 is in a fully collapsed position to thereby retain the golf cart 1 in a fully collapsed position.

While various embodiments of golf cart 1 include four (4) wheels (FIGS. 1-5 & 8), alternative embodiments include either fewer than four wheels or more than four wheels. For example, some embodiments of golf cart 1 could have three (3) wheels. In some embodiments, the front wheel assembly 24 comprises a single wheel while the rear wheel assembly 26 comprises a dual wheel configuration. In other embodiments, on the other hand, rear wheel assembly 26 comprises a single wheel while the front wheel assembly 24 comprises a dual wheel configuration. In the various embodiments, the legs associated with either the front wheel assembly 24 or the rear wheel assembly 26 (whether one leg, two legs, or more legs) can be rigid, fixed, pivotal, bifurcated, and/or slidable in relation to the body of the golf cart 1 as described with reference to the other embodiments depicted in the Figures and discussed previously. Moreover, in the various embodiments, whether golf cart 1 is configured with two legs in front, one leg in front, two legs in back and/or one leg in back, the manner in which the legs retract as the golf cart 1 is collapsed, on the one hand, and displace as the golf cart 1 is expanded, on the other, is accomplished in a similar manner to that described with reference to other embodiments above. In this way, various embodiments of golf cart 1, including three wheeled embodiments, are capable of expanding for broad, stable, rolling use and contracting for efficient and compact handling, storage and transportation. Moreover, in such embodiments, a golf club bag can remain permanently attached to the golf cart 1.

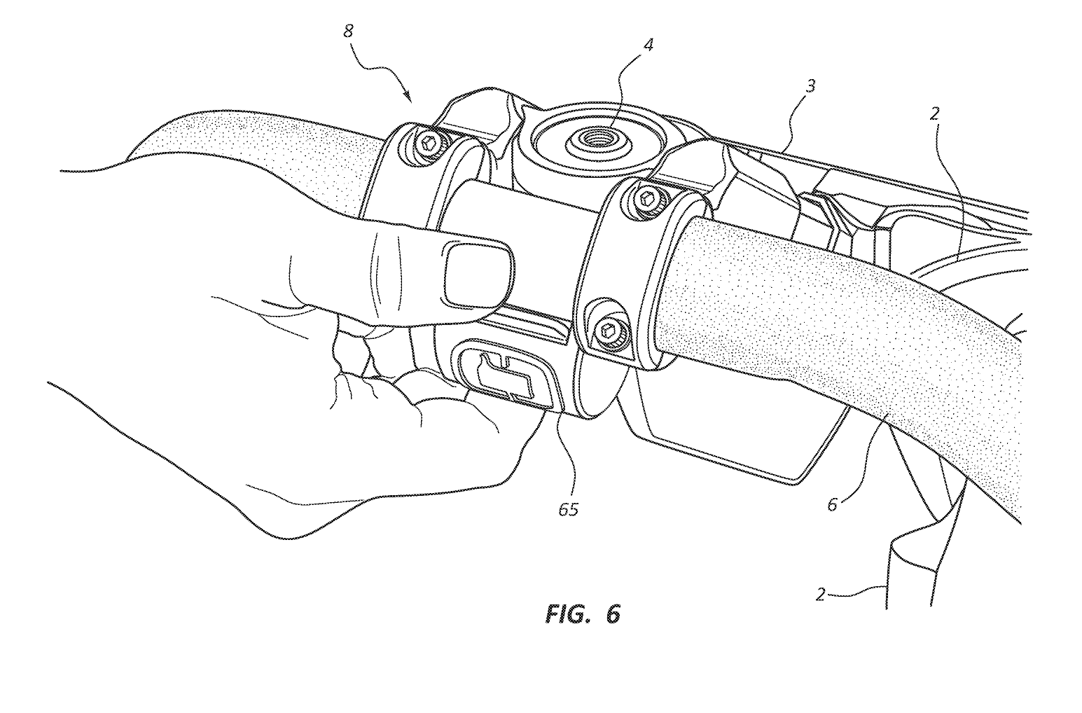

Some embodiments further include a brake system 60. Some embodiments of brake system 60 comprise a braking mechanism 61 (not shown), a cable or hydraulic line 62 (FIG. 2), and an actuation lever 65 (FIG. 6). In such embodiments, braking mechanism 61 is adapted to either directly or indirectly engage one or more of the first front wheel 28, the second front wheel 30, the first rear wheel 32, and/or the second rear wheel 34 such that the wheels 28, 30, 32, and/or 34 are restrained against rolling movement by such engagement. Braking mechanism 61 may be formed of various components common to those of skill in the art such as brake pads, brake shoes, drums, calipers, rotors, pistons, cylinders, pivoting tabs or tines and corresponding slots or cavity configurations, and so forth. In some embodiments, braking mechanism 61 is actuated remotely via the cable or hydraulic line 62 and actuation lever 65. For example, in some embodiments actuation lever 65 is located proximate the handle 6 and connected via cable or hydraulic line 62 to braking mechanism 61. In this way, brake system 60 may be actuated remotely by manipulating actuation lever 65. In some embodiments, actuation lever 65 is capable of being selectively locked or otherwise restrained against movement such that once brake system 60 is actuated, it remains actuated until actuation lever 65 is unlocked. In this way, golf cart 1 can be continuously restrained against rolling movement while permitting the user to temporarily step away from golf cart 1.

In some embodiments, golf cart 1 is constructed of light materials, and does not appreciably add to the overall weight of a golf club bag (not shown) with a standard set of clubs and other golf gear normally carried with a golf club bag. According to such embodiments, when golf cart 1 is in a collapsed configuration, the golf club bag and golf cart combination can be handled together, carried from a shoulder strap of the bag, carried from a handle on the bag, or carried by the frame of the golf cart itself just as easily and conveniently as handling or carrying the bag itself. As a result, in such embodiments golf cart 1 can be left permanently attached to the golf club bag thereby eliminating both the inconvenience of having to carry and/or stow the golf cart as a separate piece of equipment and the necessity of repeatedly attaching and detaching the bag from the cart before and after every use. In some embodiments, golf cart 1 is compact and light enough to be permanently attached to the golf club bag and can easily be attached to most standard golf bags giving the user a choice of using any brand of golf bag they might prefer or already own. Thus, in order to use the cart, users are not limited to a dedicated, specially designed golf bag.

In various embodiments, the several component parts and/or subassemblies comprising golf cart 1 can be made from any suitable materials having any characteristics, qualities, properties, geometry and/or shape suitable to the intended purpose of golf cart 1. In some embodiments, several components of golf cart 1 may be manufactured with various tabs, slots, extensions, flaps, flanges, brakes, bends, curves, corners, creases, corrugations, crimps or other stylized shapes in order to enhance the structural integrity of the golf cart 1 or to facilitate the streamlined design and/or functionality of golf cart 1. In addition, golf cart 1 may include additional features and/or components, such as straps adapted to facilitate carrying the golf cart 1, without departing from its essential characteristics or components.

FIG. 8 depicts an interlocking mechanism 90 to provide additional structural support. Interlocking mechanism 90 comprises a wire loop 92, a lever arm 94 and an engagement arm 96. When the cart is being changed from its contracted state to the extended state, some embodiments provide interlocking mechanism go to provide additional structural support. Engagement arm 96 is extended as shown in FIG. 2 and engages wire loop 92 as shown in FIG. 10. Engagement arm 96 is coupled to lever arm 94 so that actuation of lever arm 94 extends engagement arm 96 outwardly toward wire loop 92. After capture of wire loop 92 by engagement arm 96, lever arm 94 is pressed toward wire loop 92 to utilize an offset pivot point to bias engagement arm 96 away from wire loop 92 and create tension as shown in FIG. 11. FIG. 12 illustrates lever arm 94 in its locked position over wire loop 92 and engagement arm 96. Tension between the to 46 of longitudinal support beam 44 and extension member 7 of handle 8, keeps the cart from contracting during use and provides handle assembly B with support.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A foldable golf cart, comprising:
a transmission system;
a handle assembly coupled to the transmission system; and
one of a front wheel assembly and a rear wheel assembly coupled to the transmission system.

2. The foldable golf cart of claim 1, further comprising a golf club bag cradle assembly coupled to the transmission system.

3. The foldable golf cart of claim 1, further comprising a brake system.

4. The foldable golf cart of claim 1, wherein the foldable golf cart has a folded configuration and an unfolded configuration and wherein the foldable golf cart is configured to be permanently attached to a golf club bag.

5. The foldable golf cart of claim 3, wherein the brake system is selectively lockable.

6. The foldable golf cart of claim 4, wherein the foldable golf cart is selectively lockable in the unfolded configuration.

7. The foldable golf cart of claim 1, wherein the transmission system comprises a longitudinal body of the foldable golf cart which is configured to transmit a force applied from the handle assembly to the front wheel assembly and the rear wheel assembly simultaneously such that the foldable golf cart is transitioned between a folded configuration and an unfolded configuration by the application of the force.

8. The foldable golf cart of claim 7, wherein the front wheel assembly further comprises a first front wheel having a first offset connection with a first leg and a second front wheel having a second offset connection with a second leg.

9. The foldable golf cart of claim 8, wherein one of the first leg and the second leg comprise a bifurcated leg system.

10. The foldable golf cart of claim 9, wherein the first front wheel and the second front wheel simultaneously rotate longitudinally and translate laterally toward the longitudinal body of the foldable golf cart as a downward force is applied to the handle assembly, and away from the longitudinal body of the foldable golf cart as an upward force is applied to the handle assembly.

11. The foldable golf cart of claim 7, wherein the rear wheel assembly further comprises a first rear wheel having a first offset connection with a third leg and a second rear wheel having a second offset connection with a fourth leg.

12. The foldable golf cart of claim 11, wherein the third leg and the fourth leg are coupled to a primary slidable coupler which is slidably attached to the transmission system of the foldable golf cart such that the first rear wheel and the second rear wheel slide longitudinally toward the longitudinal body of the foldable golf cart as a downward force is applied to the handle assembly, and away from the longitudinal body of the foldable golf cart as an upward force is applied to the handle assembly.

13. The foldable golf cart of claim 11, wherein one of the third leg and the forth leg comprise a bifurcated leg system.

14. A foldable golf cart, comprising:
a transmission system;
a handle assembly pivotally coupled to the transmission system;
a front wheel assembly comprising a first front wheel and a second front wheel, wherein the front wheel assembly is pivotally coupled to the transmission system; and
a rear wheel assembly comprising a first rear wheel and a second rear wheel, wherein the rear wheel assembly is slidably coupled to the transmission system.

15. The foldable golf cart of claim 14, further comprising a golf club bag cradle assembly pivotally coupled to the transmission system.

16. The foldable golf cart of claim 14, wherein the foldable golf cart has a folded configuration and an unfolded configuration and wherein the foldable golf cart is configured to be permanently attached to a golf club bag.

17. The foldable golf cart of claim 14, wherein the transmission system further comprises a central support member, a primary pivot coupler, a longitudinal stay and an actuation system.

18. The foldable golf cart of claim 17, wherein the actuation system is selectively lockable.

19. The foldable golf cart of claim 14, wherein the foldable golf cart further comprises one or more struts configured to facilitate the pivotal coupling of the front wheel assembly to the transmission system.

20. The foldable golf cart of claim 14, wherein the foldable golf cart further comprises a primary slidable coupler configured to facilitate the slidable coupling of the rear wheel assembly to the transmission system.

21. The foldable golf cart of claim 20, wherein the longitudinal stay is pivotally coupled between the primary pivot coupler and the primary slidable coupler.

22. A rolling chassis transmission system, comprising
a longitudinal support beam comprising a first channel, wherein the longitudinal support beam has a first end and a second end;
a central support member comprising a second channel, wherein the central support member has a first end and a second end, and wherein the first end of the central support member is pivotally coupled to the first end of the longitudinal support beam;
a primary pivot coupler slidably engaged with the first channel of the longitudinal support beam;
a primary slidable coupler slidably engaged with the second channel of the central support member;
a longitudinal stay having a first end and a second end wherein the first end of the longitudinal stay is pivotally coupled to the primary slidable coupler and the second end of the longitudinal stay is pivotally coupled to the primary pivot coupler; and
a handle assembly comprising a first pivot point and a second pivot point, wherein the second end of the central support member is pivotally coupled to the first pivot point of the handle assembly and the primary pivot coupler is pivotally coupled to the second pivot point of the handle assembly.

23. The rolling chassis transmission system of claim 22, further comprising a selectively lockable actuation system.

24. The rolling chassis transmission system of claim 22, further comprising one or more bifurcated legs having a first end and a second end, wherein the first end of the one or more bifurcated legs is pivotally coupled to one of the central support member and the longitudinal support beam.

25. The rolling chassis transmission system of claim 24, further comprising one or more struts having a first end and a second end wherein the first end of the one or more struts is pivotally coupled to one of the one or more bifurcated legs, and wherein the second end of the one or more struts is pivotally coupled to one of the central support member, the primary pivot coupler and the handle assembly.

26. The rolling chassis transmission system of claim 25, wherein the rolling chassis transmission system has a folded configuration and an unfolded configuration.

27. The rolling chassis transmission system of claim 26, wherein the rolling chassis transmission system is configured such that a force applied from the handle assembly is transmitted to the one or more bifurcated legs and the primary slidable coupler such that the rolling chassis transmission system is transitioned between the folded configuration and the unfolded configuration.

28. The rolling chassis transmission system of claim 27, wherein the primary pivot coupler slides toward the first end of the longitudinal support beam and the primary slidable coupler slides toward the first end of the central support member as the rolling chassis transmission system is transitioned from the folded configuration to the unfolded configuration.

29. The rolling chassis transmission system of claim 28, wherein the handle assembly and the one or more bifurcated legs rotate as the rolling chassis transmission system is transitioned from the folded configuration to the unfolded configuration.

30. A four wheeled foldable golf cart designed to permanently attach to a variety of golf bags allowing compact storage in a contracted configuration; the cart comprising: a) structural members to retain wheels near a bag in a contracted configuration; b) in an extended configuration structural members that provide support by selectively interlocking.
